(19) United States
(12) Patent Application Publication
(10) Pub. No.: US 2003/0085265 A1
(43) Pub. Date: May 8, 2003

(54) Packing with reusable sealable closure

(76) Inventor: Eyal Haim, Moshav Tzur Moshe (IL)

Correspondence Address: William H. Dippert, Reed Smith LLP, 29th Floor, 599 Lexington Avenue, New York, NY, 10022-7650, US

(21) Appl. No.: 10/271,610

(22) Filed: Oct. 15, 2002

(30) Foreign Application Priority Data
Nov. 4, 2001 (IL) 146.320

(51) Int. Cl. B65D 43/02

(52) U.S. Cl. 229/123.1; 229/125.37

(57) ABSTRACT

A packing for products to be consumed in multiple portions with sealable closure for repeated use, said packing comprising a box provided with an opening; a closure adapted to substantially close said opening; sealing adapted to connect between said closure and said opening so that the closure alternatively allows passage of the product through said opening or sealingly blocks said opening, whereby said closure can be repeatedly removed in order to open said opening and when said closure is sealingly connected to said opening, the product left in the packing is preserved.

### FIELD OF INVENTION

The present invention is related to packing. More particularly, the present invention is related to packing having a reusable closure provided with resealable label for preserving the food inside the package.

### BACKGROUND OF THE INVENTION

Foods are packed in several forms; solids, liquids or mixtures of both. Food packaging is a known art, whether for industrial use or for home use. Many of the foods that are packed for home use such as food powders, herbs and spices, cereals, soups, milk, wafers, etc., are packed in relatively small amounts that suffice for several uses. After the package is opened for the first time, it cannot normally be sealed properly and the food inside may be wasted or loose some of its quality and freshness due to humidity in the air. Many foods are wasted also due to penetration of organisms to the bags or packages.

There were attempts to provide sealing means for food packages such as ZIP lock closures or clips and stickers for soft bags and tacked tabs for carton bags. In some of the cases plastic boxes are used. These solutions and other available solutions may increase the price of food in a non-proportional manner and some of them are not environmental friendly. It is preferable to provide a solution that incorporate cardboard or other paper materials as the raw material for the packing due to the advantages of using these materials. Among the advantages are the convenience and esthetics of using cardboard and the convenience also in the production processes due to the space the cardboard hold as raw material (sheets).

There is a need to provide a simple solution for food packing that maintains the price of the packaged food reasonably low and at the same time preserves the quality and freshness of the food so that the package may be opened and closed as many times as needed. Although the examples given herein are mainly from the food industry, it is emphasized that the packing of the present invention can be applied to other product packing as well.

### SUMMARY OF THE INVENTION

It is an object of the present invention to provide new packing having a reusable closure for preserving stored product. The reusable closure is sealed when the packing is not in use or stored, even after the packing is opened for the first time. The new packing may be applied for the food industry as well as for other packing solutions.

It is another object of the present invention to provide a new sealing means to seal a reusable closure in food boxes.

There is thus provided a packing for products to be consumed in multiple portions with sealable closure for repeated use, said packing comprises:

a box provided with an opening;

a closure adapted to substantially close said opening;

sealing means adapted to connect between said closure and said opening so that the closure alternatively allows passage of the product through said opening or sealingly blocks said opening,

whereby said closure can be repeatedly removed in order to open said opening and when said closure is sealingly connected to said opening, the product left in the packing is preserved.

Furthermore, in accordance with another preferred embodiment of the present invention, said sealing means is a resealable label.

Furthermore, in accordance with another preferred embodiment of the present invention, said sealing means is a resealable label, and wherein a portion of said resealable label is adhered to said closure and another portion of said resealable label is alternately adhered to an edge of said opening so that when said another portion of the resealable label is not adhered to the edge, passage of product through said opening is allowed.

Furthermore, in accordance with another preferred embodiment of the present invention, said edge of said opening on which the portion of resealable label is adhered is laminated in order to facilitate adherence.

Furthermore, in accordance with another preferred embodiment of the present invention, a part of said resealable label is lack of adhesive material and facilitates releasing the portion that is adhered to the edge of said opening.

Furthermore, in accordance with another preferred embodiment of the present invention, said closure is incised from said box so as to form the opening.

Furthermore, in accordance with another preferred embodiment of the present invention, said closure is partially incised from said box so as to form the opening.

Furthermore, in accordance with another preferred embodiment of the present invention, said box is a salt cellar.

Furthermore, in accordance with another preferred embodiment of the present invention, said box is made from a paper board such as carton.

Furthermore, in accordance with another preferred embodiment of the present invention, the external surface of said carton is laminated.

Furthermore, in accordance with another preferred embodiment of the present invention, the surface is laminated with a material selected from the group of polyester, polyethylene and polypropylene.

Furthermore, in accordance with another preferred embodiment of the present invention, the internal surface of said box is laminated.

Furthermore, in accordance with another preferred embodiment of the present invention, said opening is extended on at least one side of said box.

Furthermore, in accordance with another preferred embodiment of the present invention, said opening is extended on both sides of said box.

Furthermore, in accordance with another preferred embodiment of the present invention, said product is food.

Finally, there is provided in accordance with yet another preferred embodiment of the present invention, a packing for products to be consumed in multiple portions with sealable closure for repeated use, said packing comprises:

a box provided with at least one opening;

at least one closure, each of the closures is adapted to substantially close one of the openings;

sealing means adapted to connect between said at least one closure and said at least one opening so that the closure alternatively allows passage of the product through the opening or sealingly blocks the opening,

whereby said at least one closure can be repeatedly removed in order to open the opening and when the closure is sealingly connected to the opening, the product left in the packing is preserved.

### BRIEF DESCRIPTION OF THE FIGURES

FIG. 1 illustrates a package sheet in accordance with a preferred embodiment of the present invention.

FIG. 2 illustrates the package sheet shown in FIG. 1, provided with a multiple use sealing means in accordance with a preferred embodiment of the present invention.

FIG. 3 illustrates the package sheet shown in FIG. 2 arranges as a box and in a closed state.

FIG. 4 illustrates a box provided with two multiple use closures in accordance with another preferred embodiment of the present invention.

FIG. 5 illustrates a cereal package provided with a sealing means in accordance with another preferred embodiment of the present invention.

FIG. 6 illustrates an instant soup box having a multiple use closure in accordance with another preferred embodiment of the present invention.

FIG. 7 illustrates a salt cellar having a multiple use closure in accordance with another preferred embodiment of the present invention.

FIG. 8 illustrates a closed box having a multiple use closure in accordance with another preferred embodiment of the present invention, while the opening is positioned on two sides of the box.

FIG. 9 illustrates the box shown in FIG. 8, in an open state.

### DETAILED DESCRIPTION OF THE INVENTION AND FIGURES

The present invention provides a new packing having a sealable reusable closure that may be opened and sealingly closed for as many times as needed. When a food package provided with a sealing means in accordance with the preferred embodiments of the present invention is opened for the first time and stored until the next portion is taken, the food inside the package is preserved in maximal conditions without allowing humidity or organisms to penetrate the package.

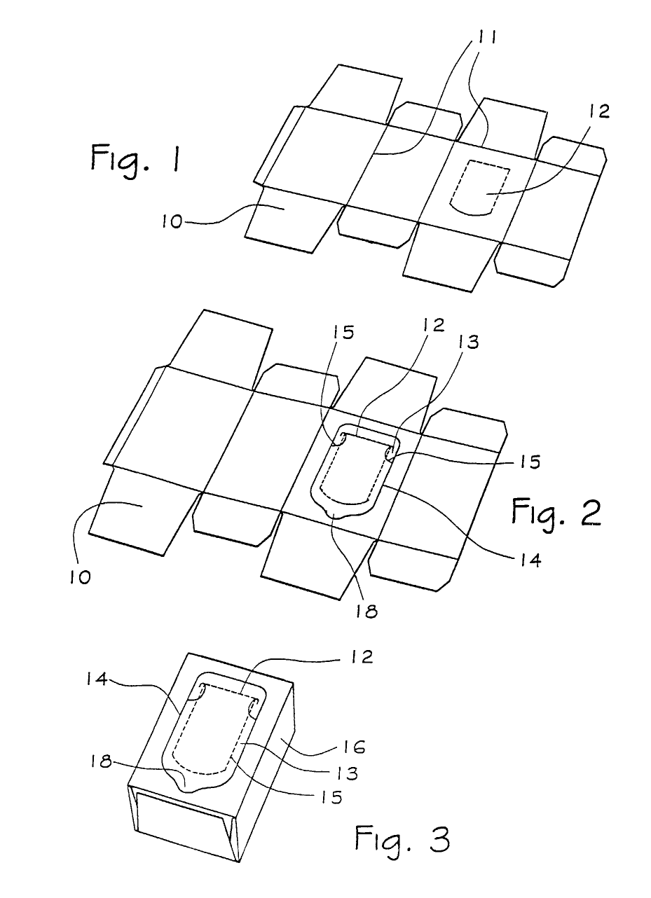

Reference is made to FIG. 1, illustrating a package sheet in accordance with a preferred embodiment of the present invention. Package 10 is preferably made of a relatively stiff material such as paper board that may be easily folded according to fold lines 11 to present a box. The cardboard may preferably be laminated with a polymeric material. One side of package sheet 10 is provided with an incised portion that acts as closure 12.

Closure 12 covers an opening that is formed in the package. Closure 12 may be incised from all sides such as in the shown embodiment or partially incised.

Generally, the closure is adapted to substantially close the opening. The edges of both the opening and the closure may be partially or totally overlapping in the edges or the edges may in some extent be distant from one another.

Reference is now made to FIG. 2 illustrating the package sheet shown in FIG. 1, provided with a multiple use sealing means in accordance with a preferred embodiment of the present invention. The sealing means may be a pressure sensitive label, preferably a resealable label 13 that covers all sides and edges of closure 12 as well as a portion of package 10 itself so that the edge 14 of resealable label 13 is fully positioned on package 10. A small portion 18 of resealable label 13 is depleted of adhesive material so that the user may lift the incised portion easily.

Reference is now made to FIG. 3, illustrating the package sheet shown in FIG. 2 arranges as a box and in a closed state. Package sheet 10 is folded according to the fold lines so that box 16 is formed. After the sheet had been folded, the box is secured using resealable label, glue, soldering, stickers or any other available technology. The box may contain a product from any kind, such as food, detergents and the like. If the food is substantially dry and in the shape of flakes, powder and the like, a carton box may be used in order to reduce costs. The carton box may be bare internally and laminated with thermoplastic polymers such as polyester, polyethylene or polypropylene that is covered externally. If the food is semi-solid or liquid, a cardboard material may be also used, laminated internally as well as externally. These features reduce the cost of packaging since in a case of solid and substantially dry food, there is no need to use an additional soft bag that contains the food to be put in the box. The fact that the opening may be sealingly closed by the closure when the box is stored enables keeping the solid food in the box itself. It is optional to provide the resealable label with incisions 15 that facilitate keeping the opening open as will be shown and explained hereinafter. It should be noted that the opening may be provided on more than one side of the box while the packaging may be in any shape.

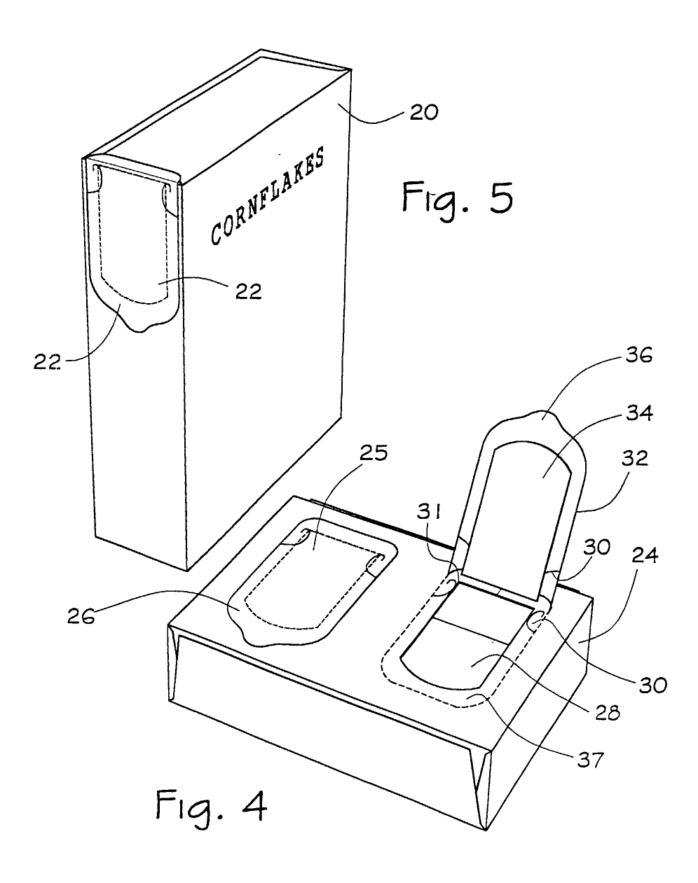

Reference is now made to FIG. 4 illustrating a box provided with two multiple use closures in accordance with another preferred embodiment of the present invention. Box 24 is folded and has two openings at its topside. A box having more than one opening may be provided with partition boards so that the box has more than one compartment and each compartment is provided with an opening that may be closed in accordance with the present invention or combines with other closures. The box may be also provided with other articles such as a window laminated with a transparent material that enables the consumer to view the product. The closures of box 24 are both provided with resealable labels so as to seal the openings when they are closed. Opening 25 is provided with resealable label 26 and is in a closed state so that the edges of resealable label are adhered on the box from all sides of opening 25. This adhered zone provides sealing for the opening from all sides so that the content inside the box remains protected and fresh.

Opening 28 is also provided at the topside of box 24. Opening 28 is formed from the incision of a portion 34 of the box—a portion that acts as the closure. When the closure is lifted, opening 28 is in an open state. Portion 34 is provided with a resealable label 32 that covers the opening such as resealable label 26 covers opening 25. Resealable label 32 protrudes from the sides of portions 34 so that it is adhered to zone 37 of box 24 when the closure is closed. The adherence of resealable label 32 to zone 37 is improved if the box including zone 37 is laminated. This is another advantage of the external lamination. The sealing between the closure and the box is enhanced due to the presence of the lamination. In order to facilitate lifting of portion 34, a small part of resealable label 36 is depleted from adhesive material so that the user may hold it so as to facilitate releasing resealable label 32 from box 24. Portion 34 that acts as the closure remains adhered to resealable label 32. One side 31 of resealable label 32 stays adhered to box 24 while incisions 30 facilitate maintaining portion 34 lifted.

In order to close opening 28, portion 34 and resealable label 32 are dropped down to a closed state wherein the resealable label seals opening 28 from all sides.

Reference is now made to FIG. 5 illustrating a cereal package provided with a sealing means in accordance with another preferred embodiment of the present invention. The present invention may be applied to solid foods such as cereals. Box 20 is an example for a cornflakes package. Cornflakes are examples for foods that loose their taste and texture upon contact with humidity in open air. Cornflakes are sold in packages that are adequate to a few meals. Commonly, cornflakes are sold in carton boxes that contain the flakes in a foldable plastic bag that may be folded after opening in order to keep the content fresh. The double packaging increases the cost of the cereal and at the same time does not provide a suitable solution for preserving the inside product since folding the inside bag after the box has been opened for the first time is not sufficient in order to prevent humidity from entering the bag. Box 20, on the other hand, may contain the cornflakes without the need of an inside bag while closure 22 is sealed with an resealable label 21 that prevents humidity from the air to enter through the closure 22.

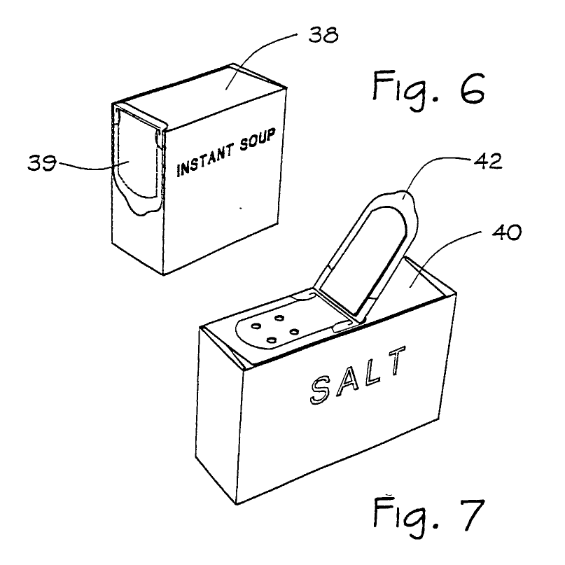

Reference is now made to FIG. 6 illustrating an instant soup box having a multiple use opening in accordance with another preferred embodiment of the present invention. Different food powders are also examples for foods that are wasted when left open to the air. In order to prevent the ruin of the powders, a use of a box having a multiple use closure of the present invention is desires. In order to keep powders sealed in a box, it is customary to use a plastic box, a fact that significantly increases the cost of the packaged powder. Box 38 is an example of a box for instant soup that is also used in small amounts for a long time. Providing a sealed closure 39 for multiple uses according to the present invention keeps the powdered food from being in contact with the outside air; hence preserving the food's freshness, and reducing the cost of the packaging.

Packing with sealed closure in accordance with the present invention may be used also in packages of liquid or semi-liquid foods. The packing may be applied also to ice creams that are kept in the freezer for a long time while they are open many times in order to take a portion. In this case, special resealable label may be used, a tape that is not ruined in wet conditions.

Reference is now made to FIG. 7 illustrating a salt cellar having a reusable closure in accordance with another preferred embodiment of the present invention. Salt cellars that are provided with a closure that closes the small holes by protrusions in the closure are available. The closure of salt cellar 40 is provided with a resealable label 42 that seals the closure and prevents humidity from entering the inside box and be adsorbed in the salt. Other spices and herbs may be packaged in a similar way and still be covered by the scope of the present invention.

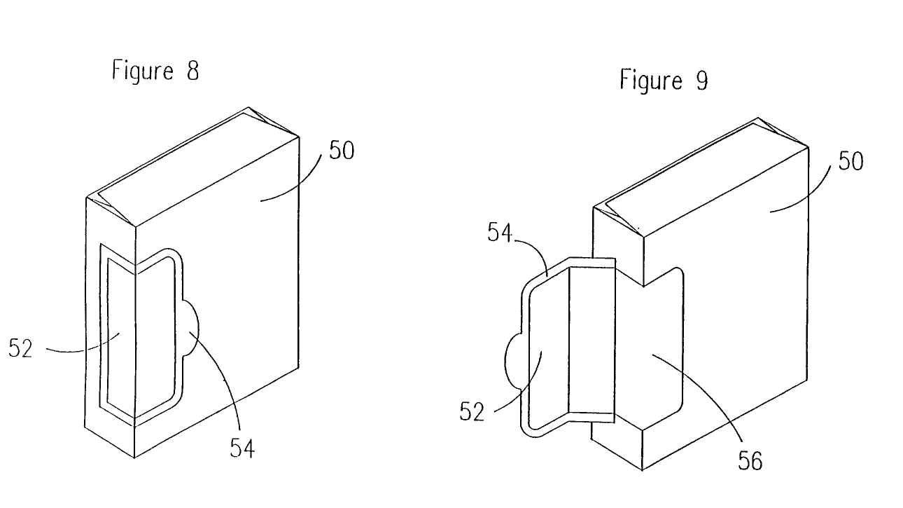

Reference is now made to FIG. 8 illustrating a closed box having a multiple use closure in accordance with another preferred embodiment of the present invention, while the opening is positioned on two sides of the box. Box 50 is provided with an opening that is extended over more than one side of the box, preferably over two sides. Closure 52 is incised over two sides of box 50 and a resealable label 54 extends and protrudes from all edges of closure 52 so that it is adhered on the laminated box.

Reference is now made to FIG. 9 illustrating the box shown in FIG. 8, in an open state. Closure 52 that is incised from both sides of box 50 is open while keeping the cornered shape of closure 52. Opening closure 52 uncovers opening 56 and closing closure 52 back while adhering resealable label 54 on the laminated edge of the opening, seals the closure.

It is emphasized that the multiple use closure in accordance with preferred embodiments of the present invention may be applied also in nonfood applications. Another example in which the use of packing with sealable closure for multiple uses may be applied to is the detergent industry. These products are also sensitive to humidity and are supposed to be consumed in many portions. Therefore, after the initial opening of the package, the opening has to be tightly sealed. There are other applications as well that are covered by the scope of the present invention.

It should be clear that the description of the embodiments and attached Figures set forth in this specification serves only for a better understanding of the invention, without limiting its scope as covered by the following claims.

It should also be clear that a person in the art, after reading the present specification could make adjustments or amendments to the attached Figures and above described embodiments that would still be covered by the following claims.

1. A packing for products to be consumed in multiple portions with sealable closure for repeated use, said packing comprises:
a box provided with an opening;
a closure adapted to substantially close said opening;
sealing means adapted to connect between said closure and said opening so that the closure alternatively allows passage of the product through said opening or sealingly blocks said opening,
whereby said closure can be repeatedly removed in order to open said opening and when said closure is sealingly connected to said opening, the product left in the packing is preserved.

2. The packing as claimed in claim 1, wherein said sealing means is a resealable label.

3. The packing as claimed in claim 1, wherein said sealing means is a resealable label, and wherein a portion of said resealable label is adhered to said closure and another portion of said resealable label is alternately adhered to an edge of said opening so that when said another portion of the resealable label is not adhered to the edge, passage of product through said opening is allowed.

4. The packing as claimed in claim 3, wherein said edge of said opening on which the portion of resealable label is adhered is laminated in order to facilitate adherence.

5. The packing as claimed in claim 3, wherein a part of said resealable label is lack of adhesive material and facilitates releasing the portion that is adhered to the edge of said opening.

6. The packing as claimed in claim 1, wherein said closure is incised from said box so as to form the opening.

7. The packing as claimed in claim 1, wherein said closure is partially incised from said box so as to form the opening.

8. The packing as claimed in claim 1, wherein said box is a salt cellar.

9. The packing as claimed in claim 1, wherein said box is made from a paper board such as carton.

10. The packing as claimed in claim 9, wherein the external surface of said carton is laminated.

11. The packing as claimed in claim 10, wherein the surface is laminated with a thermoplastic polymer.

12. The packing as claimed in claim 11, wherein said thermoplastic polymer is selected from the group of polyester, polyethylene and polypropylene.

13. The packing as claimed in claim 1, wherein the internal surface of said box is laminated.

14. The packing as claimed in claim 1, wherein said opening is extended on at least one side of said box.

15. The packing as claimed in claim 14, wherein said opening is extended on both sides of said box.

16. The packing as claimed in claim 1, wherein said product is food.

17. A packing for products to be consumed in multiple portions with sealable closure for repeated use, said packing comprises:
a box provided with at least one opening;
at least one closure, each of the closures is adapted to substantially close one of the openings;
sealing means adapted to connect between said at least one closure and said at least one opening so that the closure alternatively allows passage of the product through the opening or sealingly blocks the opening,
whereby said at least one closure can be repeatedly removed in order to open the opening and when the closure is sealingly connected to the opening, the product left in the packing is preserved.
